(19) United States
(12) Patent Application Publication
(10) Pub. No.: US 2022/0035152 A1
(43) Pub. Date: Feb. 3, 2022

(54) LASER STABILIZING SYSTEM AND LASER SOURCE MODULE

(71) Applicant: National Cheng-Kung University, Tainan City (TW)

(72) Inventors: Chien-Sheng Liu, Tainan City (TW); Yu-Hao Chang, Tainan City (TW); Chih-Hao Tsai, Taichung City (TW)

(73) Assignee: National Cheng-Kung University, Tainan City (TW)

(21) Appl. No.: 17/019,374

(22) Filed: Sep. 14, 2020

(30) Foreign Application Priority Data
Jul. 29, 2020 (TW) 109125531

(51) Int. Cl. G02B 27/00; G02B 26/08; H01S 3/00; H01S 5/0683

(52) U.S. Cl. CPC G02B 27/0068; H01S 5/0683; H01S 3/0071; G02B 26/0883

(57) ABSTRACT

A laser stabilizing system configured to stabilize a laser beam emitted from a laser source includes a beam steering device, a first beam splitter, a first light detector, a second beam splitter, and a second light detector. The beam steering device is configured to steer a direction and a position of the laser beam in four or more degrees of freedom. The first beam splitter is configured to split the laser beam from the beam steering device into a first partial beam and a second partial beam. The first light detector is disposed on a transmission path of the first partial beam. The second beam splitter is configured to split the second partial beam into a third partial beam and a fourth partial beam. The second light detector is disposed on a transmission path of the third partial beam. A laser source module is also provided.

### CROSS-REFERENCE TO RELATED APPLICATION

This application claims the priority benefit of Taiwan application serial no. 109125531, filed on Jul. 29, 2020. The entirety of the above-mentioned patent application is hereby incorporated by reference herein and made a part of this specification.

### BACKGROUND

### Technical Field

The disclosure relates to an optical system and a light source module, and in particular, to a laser stabilizing source system and a laser source module.

### Description of Related Art

With the advancement of science and technology, laser sources are widely used in various fields, and related industries can produce high-quality and high-precision products of high unit prices. Many studies show that the accuracy and stability of a laser source are affected by not only the external environment temperature and vibration, but also its own structure, the heat source, the input source, etc. Therefore, if the above issues are overcome, the quality of a laser source can be improved, and the accuracy and value of a laser instrument can be further improved.

A current laser stabilizing system on the market is composed of two fast steering mirrors (FSM) that swing in two degrees of freedom and two sensors. The two sensors are configured to measure a laser source, transmit data to a controller, and analyze a geometric laser error through an algorithm. Then, the controller drives the two fast steering mirrors that swing in two degrees of freedom, to compensate an error of four degrees of freedom for the laser source. In addition, the fast steering mirror on the market includes an actuator with two degrees of freedom that can reflect and control the direction of a laser beam by enabling a plane mirror mounted on the fast steering mirror to rotate about two mutually perpendicular axes.

However, the current fast steering mirror on the market can only enable the laser beam to deflect in two degrees of freedom, and cannot enable the laser beam to translate. In addition, a laser stabilizing source system including the currently commercially available fast steering mirror has excessive parts and is not suitable to be mounted in a small space. Furthermore, the laser stabilizing source system including the currently commercially available fast steering mirror has an excessively long optical path, which enlarges an angular error of a laser beam.

### SUMMARY

The invention provides a laser stabilizing system that can enable a laser beam to deflect and translate, is easily mounted in a narrow space, and may have a shorter optical path length, thereby effectively reducing an angle error of the laser beam.

The invention provides a laser source module that can enable a laser beam to deflect and translate, is easily mounted in a narrow space, and may have a shorter optical path length, thereby effectively reducing an angle error of the laser beam.

An embodiment of the invention provides a laser stabilizing system configured to stabilize a laser beam emitted from a laser source. The laser stabilizing system includes a beam steering device, a first beam splitter, a first light detector, a second beam splitter, and a second light detector. The beam steering device is disposed on a path of the laser beam and is configured to steer a direction and a position of the laser beam in four or more degrees of freedom. The first beam splitter is disposed on a path of the laser beam from the beam steering device and is configured to split the laser beam into a first partial beam and a second partial beam. The first light detector is disposed on a transmission path of the first partial beam. The second beam splitter is disposed on a transmission path of the second partial beam and is configured to split the second partial beam into a third partial beam and a fourth partial beam. The second light detector is disposed on a transmission path of the third partial beam.

An embodiment of the invention proposes a laser source module, including a laser source, a beam steering device, a first beam splitter, a first light detector, a second beam splitter, and a second light detector. The laser source is configured to emit a laser beam. The beam steering device is disposed on a path of the laser beam and is configured to steer a direction and a position of the laser beam in four or more degrees of freedom. The first beam splitter is disposed on a path of the laser beam from the beam steering device and is configured to split the laser beam into a first partial beam and a second partial beam. The first light detector is disposed on a transmission path of the first partial beam. The second beam splitter is disposed on a transmission path of the second partial beam and is configured to split the second partial beam into a third partial beam and a fourth partial beam. The second light detector is disposed on a transmission path of the third partial beam.

In the laser stabilizing system and the laser source module in the embodiments of the invention, since the beam steering device that steers the direction and the position of the laser beam in four or more degrees of freedom is used, the laser stabilizing system and the laser source module can enable the laser beam to deflect and translate, are easily mounted in a narrow space, and may have a shorter optical path length, thereby effectively reducing the angle error of the laser beam.

### BRIEF DESCRIPTION OF THE DRAWINGS

FIG. 1 is a schematic optical path diagram of a laser source module according to an embodiment of the invention.

FIG. 2 is a schematic optical path diagram of a prism in a beam steering device in FIG. 1.

FIG. 3A is a three-dimensional schematic diagram of a beam steering device according to another embodiment of the invention.

FIG. 3B is a three-dimensional schematic diagram of the beam steering device in FIG. 3A after a part is cut off.

FIG. 4 is a three-dimensional schematic diagram of a first prism and a second prism of a beam steering device according to another embodiment of the invention.

FIG. 5 is a schematic optical path diagram of a laser source module according to still another embodiment of the invention.

### DESCRIPTION OF THE EMBODIMENTS

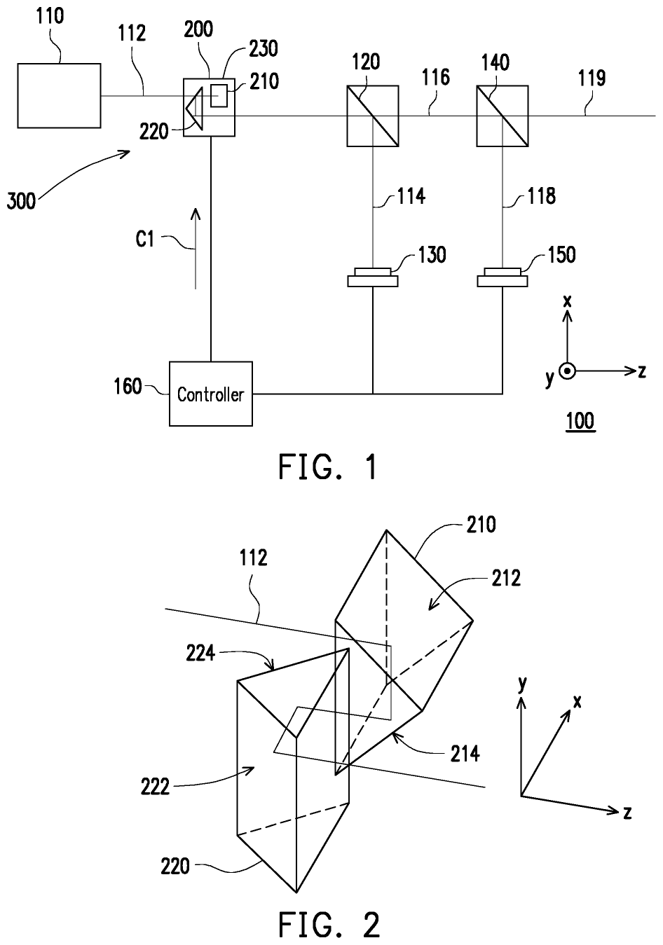

FIG. 1 is a schematic optical path diagram of a laser source module according to an embodiment of the invention. FIG. 2 is a schematic optical path diagram of a prism in a beam steering device in FIG. 1. Referring to FIG. 1 and FIG. 2, a laser source module 100 in the present embodiment includes a laser source 110, a beam steering device 200, a first beam splitter 120, a first light detector 130, a second beam splitter 140, and a second light detector 150. The laser source 110 is configured to emit a laser beam 112. The laser source 110 may have various forms, such as a solid laser source, a liquid laser source, or a gas laser source, etc.

The beam steering device 200 is disposed on a path of the laser beam 112 and is configured to steer a direction and a position of the laser beam 112 in four or more degrees of freedom. For example, the beam steering device 200 may steer the laser beam 112 in four degrees of freedom, for example, rotate the laser beam in two axial directions and translate the laser beam in two axial directions.

The first beam splitter 120 is disposed on a path of the laser beam 112 from the beam steering device 200 and is configured to split the laser beam 112 into a first partial beam 114 and a second partial beam 116. The first light detector 130 is disposed on a transmission path of the first partial beam 114. The second beam splitter 140 is disposed on a transmission path of the second partial beam 116 and is configured to split the second partial beam 116 into a third partial beam 118 and a fourth partial beam 119. The second light detector 150 is disposed on a transmission path of the third partial beam 118. In the present embodiment, the first beam splitter 120 and the second beam splitter 140 are, for example, beam splitting prisms. However, in other embodiments, the first beam splitter 120 and the second beam splitter 140 may also be beam splitting mirrors.

In the present embodiment, the first light detector 130 and the second light detector 150 are both image sensors, such as a complementary metal oxide semiconductor (CMOS) image sensor or a charge coupled device (CCD). In addition, in the present embodiment, the laser source module 100 further includes a controller 160 electrically connected to the first light detector 130, the second light detector 150, and the beam steering device 200 and configured to: calculate, according to a position of a light spot formed by the first partial beam 114 on the first light detector measured by the first light detector 130 and a position of a light spot formed by the third partial beam 118 on the second light detector measured by the second light detector 150, an angle and a position required to be compensated for the laser beam 112, and transmit a control signal C1 to the beam steering device 200 so that the beam steering device 200 compensates a deviation of the angle and the position for the laser beam 112. After the laser beam 112 is immediately and well compensated by the beam steering device 200, the fourth partial beam 119 becomes a high-precision and high-stability laser beam that may be used by the outside world, and is less affected by an external environment temperature and vibration and by a structure thereof, a heat source, and an input source thereof.

In the present embodiment, the beam steering device 200 includes a first prism 210 and a second prism 220. The first prism 210 has a first inclined reflecting surface 212, and the second prism 220 has a second inclined reflecting surface 222. The laser beam 112 is sequentially reflected by the first inclined reflecting surface 212 and the second inclined reflecting surface 222. The first inclined reflecting surface 212 is parallel to a first axial direction x, and the second inclined reflecting surface 222 is parallel to a second axial direction y. The first inclined reflecting surface 212 is inclined with respect to a direction in which the laser beam 112 is incident on the first inclined reflecting surface, and the second inclined reflecting surface 222 is inclined with respect to a direction in which the laser beam 112 is emitted from the second inclined reflecting surface. In the present embodiment, the first axial direction x and the second axial direction y are perpendicular to each other.

In addition, in the present embodiment, the first prism 210 further has a third inclined reflecting surface 214 inclined with respect to the first inclined reflecting surface 212 and parallel to the first axial direction x. The second prism 220 further has a fourth inclined reflecting surface 224 inclined with respect to the second inclined reflecting surface 222 and parallel to the second axial direction y. The laser beam 112 is sequentially reflected by the first inclined reflecting surface 212, the third inclined reflecting surface 214, the second inclined reflecting surface 222, and the fourth inclined reflecting surface 224. The third inclined reflecting surface 214 is inclined with respect to a direction in which the laser beam 112 is incident on the third inclined reflecting surface, and the fourth inclined reflecting surface 224 is inclined with respect to a direction in which the laser beam 112 is emitted from the fourth inclined reflecting surface.

In the present embodiment, the beam steering device 200 further includes a motor 230. The first prism 210 and the second prism 220 are disposed in the motor 230 so as to be controlled by the motor 230 in direction and position. In addition, in the present embodiment, the first prism 210 and the second prism 220 are disposed in a single motor 230. The single motor 230 is a motor capable of controlling in four or more degrees of freedom. For example, the motor 230 can enable the first prism 210 and the second prism 220 to translate along the first axial direction x and rotate about an axis parallel to the first axial direction x, or can enable the first prism 210 and the second prism 220 to translate along the second axial direction y and rotate about an axis parallel to the second axial direction y. In other words, the motor 230 can enable the first prism 210 and the second prism 220 to deflect and translate in four degrees of freedom. In another embodiment, the motor 230 can also enable the first prism 210 and the second prism 220 to translate along a third axial direction z and/or rotate about an axis parallel to the third axial direction z, so that the first prism 210 and the second prism 220 deflect and translate in five or six degrees of freedom. The third axial direction z is, for example, perpendicular to the first axial direction x and the second axial direction y.

Devices other than the laser source 110 (such as the beam steering device 200, the first beam splitter 120, the first light detector 130, the second beam splitter 140, the second light detector 150, and the controller 160) can form a laser stabilizing system 300 configured to maintain the laser beam 112 emitted from the laser source 110 stable.

In an embodiment, the controller 160 is, for example, a central processing unit (CPU), a microprocessor (microprocessor), a digital signal processor (DSP), a programmable controller, a programmable logic device (PLD), or other similar devices or a combination of the devices. No limitation is imposed in the invention. In addition, in an embodiment, functions of the controller 160 may be implemented as a plurality of program codes. The program codes are stored in a memory, and the controller 160 executes the codes. Alternatively, in an embodiment, each of the functions of the controller 160 may be implemented as one or more circuits. Whether the functions of the controller 160 are implemented by using software or hardware is not limited in the invention.

In the laser stabilizing system 300 and the laser source module 100 in the present embodiment, since the beam steering device 200 that steers the direction and the position of the laser beam 112 in four or more degrees of freedom is used, the laser stabilizing system and the laser source module can enable the laser beam 112 to deflect and translate, and are easily mounted in a narrow space, and may have a shorter optical path length, thereby effectively reducing the angle error of the laser beam 112. In other words, the laser stabilizing system 300 and the laser source module 100 in the embodiments may use only a single beam steering device 200 instead of two or more fast steering mirrors traditionally used, thereby effectively reducing a number of parts and achieving the above effect.

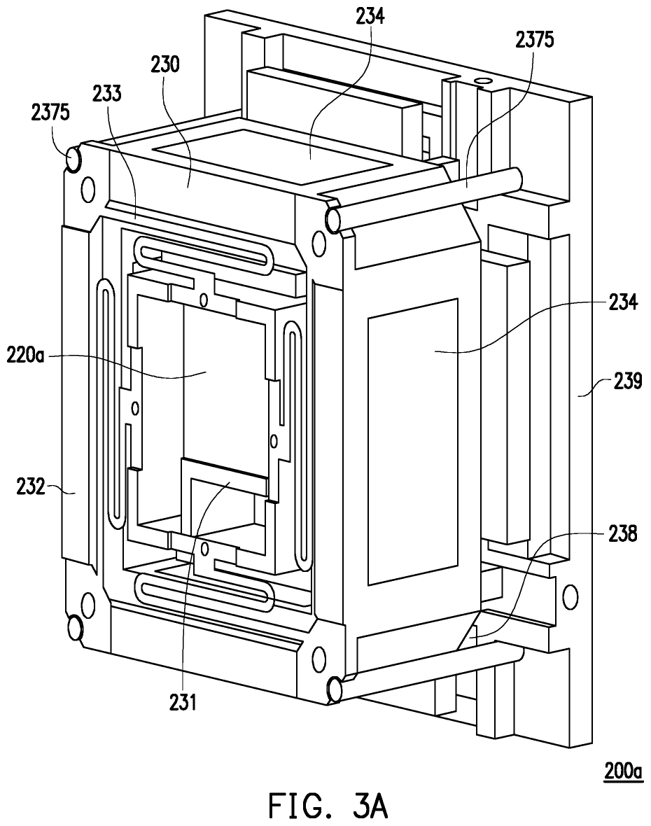

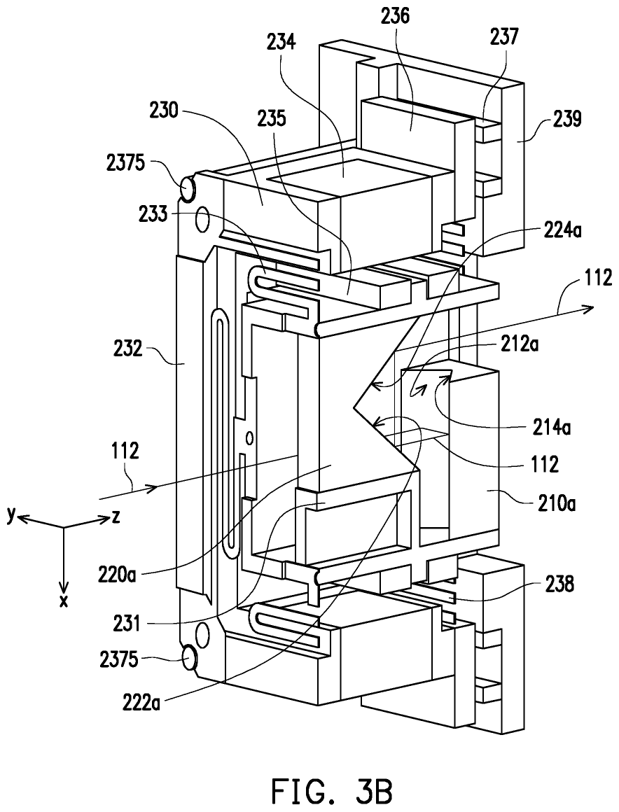

FIG. 3A is a three-dimensional schematic diagram of a beam steering device according to another embodiment of the invention. FIG. 3B is a three-dimensional schematic diagram of the beam steering device in FIG. 3A after a part is cut off. Referring to FIG. 3A and FIG. 3B, a beam steering device 200a in the present embodiment is similar to the beam steering device 200 in FIG. 1. Main differences between the two are as follows. The first prism 210 and the second prism 220 in FIG. 1 have light-transmitting materials, and the laser beam 112 can enter the light-transmitting material. The first inclined reflecting surface 212, the third inclined reflecting surface 214, the second inclined reflecting surface 222, and the fourth inclined reflecting surface 224 may be coated with a reflecting film to reflect the laser beam 112. Alternatively, the first inclined reflecting surface 212, the third inclined reflecting surface 214, the second inclined reflecting surface 222, and the fourth inclined reflecting surface 224 may reflect the laser beam 112 by means of total internal reflection, and may be coated with no reflecting film. Different from the above, in the embodiments of FIG. 3A and FIG. 3B, a first prism 210a and a second prism 220a may have light-transmitting materials or opaque materials, and the laser beam 112 does not pass through the materials of the first prism 210a and the second prism 220a. The first inclined reflecting surface 212a, the third inclined reflecting surface 214a, the second inclined reflecting surface 222a, and the fourth inclined reflecting surface 224a may be coated with a reflecting film.

Similarities between the beam steering device 200a in the present embodiment and the beam steering device 200 in FIG. 1 are as follows. The motor 230 may include a prism fixing seat 231, a magnet fixing seat 232, a plurality of upper spring sheets 233, a plurality of first magnets 234, a plurality of first coils 235, a plurality of second magnets 236, a plurality of second coils 237, a plurality of lower spring sheets 238, a plurality of elastic wires 2375, and a base 239. The prism fixing seat 231 is configured to fix the first prism 210a and the second prism 220a, and the magnet fixing seat 232 is configured to fix the first magnets 234 and the second magnets 236, and is disposed above the base 239. The first coils 235 are disposed on the prism fixing seat 231. Each of the upper spring sheets 233 and each of the lower spring sheets 238 are connected to the prism fixing seat 231 and the magnet fixing seat 232. In FIG. 3A, most of the lower spring sheets 238 are invisible as a result of being blocked by the magnet fixing seat 232. However, in fact, a manner of disposing and extending the lower spring sheet 238 is similar to a manner of disposing and extending the upper spring sheet 233. A difference between the two is that the upper spring sheet 233 is located at the top of the magnet fixing seat 232, and the lower spring sheet 238 is located at the bottom of the magnet fixing seat 232 (a part of the lower spring sheet 238 is visible in FIG. 3B) In addition, one end of the elastic wire 2375 is fixed on the base 239, and the elastic wires 2375 may respectively extend to the four corners of the magnet fixing seat 232. The second coil 237 is disposed on the base 239. When the first coil 235 is energized, the first magnet 234 generates a transverse electromagnetic force on the first coil 235. For example, an electromagnetic force toward a direction +z is applied on the first coil 235 located at the top of FIG. 3B (that is, a direction −x), and an electromagnetic force toward a direction −z is applied to the first coil located at the bottom of FIG. 3B (that is, a direction +x). In this case, the prism fixing seat 231 is rotated about the axis parallel to the second axial direction y. On the contrary, if an electromagnetic force toward a direction −z is applied on the first coil 235 located at the top of FIG. 3B (that is, the direction −x), and an electromagnetic force toward a direction +z is applied to the first coil located at the bottom of FIG. 3B (that is, the direction +x), the prism fixing seat 231 is rotated about the axis parallel to the second axial direction y in an opposite direction. The rotation of the prism fixing seat 231 drives the first prism 210a and the second prism 220a to rotate about the axis parallel to the second axial direction y.

In addition, when the second coil 237 is energized, the second coil 237 generates a transverse electromagnetic force on the second magnet 236. For example, if an electromagnetic force toward the direction −x is applied to both the second magnet 236 located at the top of FIG. 3B (that is, the direction −x) and the second magnet 236 located at the bottom of FIG. 3B (that is, the direction +x), the prism fixing seat 231 can be translated along the direction −x. On the contrary, if an electromagnetic force toward the direction +x is applied to both the second magnet 236 located at the top of FIG. 3B (that is, the direction −x) and the second magnet 236 located at the bottom of FIG. 3B (that is, the direction +x), the prism fixing seat 231 can be translated along the direction +x. The translation of the magnet fixing seat 232 can drive the first prism 210a and the second prism 220a to translate in the direction +x or the direction −x.

Most structures of the motor 230 may be symmetrical after 90-degree rotation or approximately symmetrical after 90-degree rotation, that is, the structure overlaps or substantially overlaps, or is similar to a structure before rotation after every 90-degree rotation about an axis z. Therefore, by using magnetic forces of the first coil 235 and the first magnet 234 arranged in the second axial direction y, the prism fixing seat 231 can be rotated about the axis parallel to the first axial direction. In addition, by using the second coil 237 and the second magnet 236 arranged in the second axial direction y, the prism fixing seat can be translated in a direction +y or a direction −y. In this way, the motor 230 can steer the first prism 210a and the second prism 220a in four degrees of freedom, including two degrees of freedom: translation in the first axial direction x and the second axial direction y, and other two degrees of freedom: rotation about the axis parallel to the first axial direction x and rotation about the axis parallel to the second axial direction y. The upper spring sheet 233 and the lower spring sheet 238 can achieve a balance with the above electromagnetic force, so that the prism fixing seat 231 remains stable at a specific rotation angle or position. The elastic wire 2375 can balance the electromagnetic force that causes the magnet fixing seat 232 to translate in the first axial direction x and the second axial direction y.

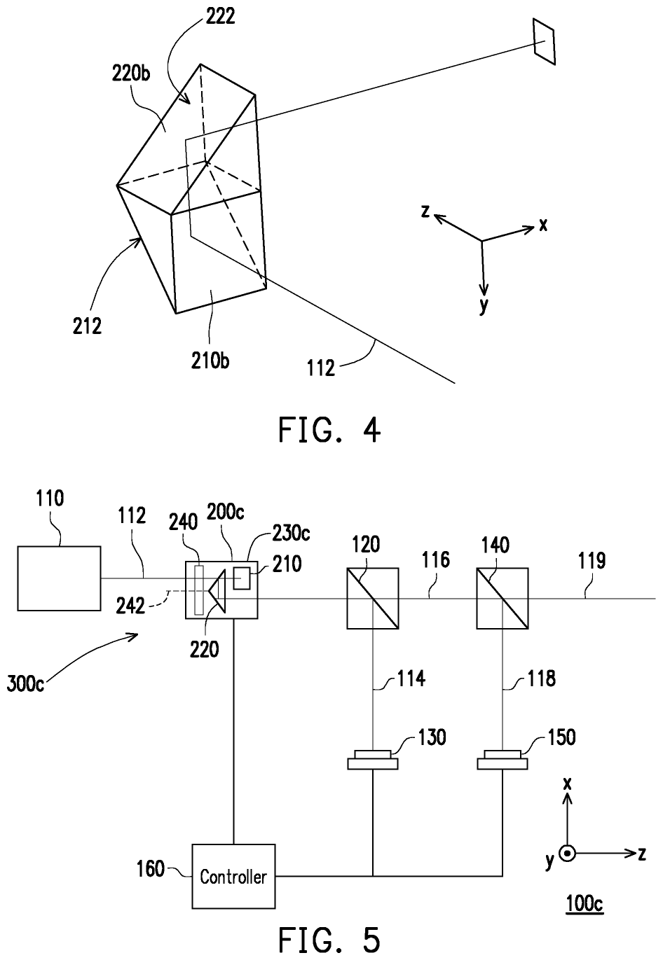

FIG. 4 is a three-dimensional schematic diagram of a first prism and a second prism of a beam steering device according to another embodiment of the invention. Referring to FIG. 4, a first prism 210b and a second prism 220b of the beam steering device in the present embodiment are similar to the first prism 210 and the second prism 220 in FIG. 2. Differences between the two are as follows. In the present embodiment, the first prism 210b has only one inclined reflecting surface (that is, the first inclined reflecting surface 212), and the second prism 220b has only one inclined reflecting surface (that is, the second inclined reflecting surface 222). The laser beam 112 is sequentially reflected by the first inclined reflecting surface 212 and the second inclined reflecting surface 222. In the present embodiment, the motor can also enable the first prism 210b and the second prism 220b to deflect and translate in four or more degrees of freedom, so that an effect of steering the laser beam 112 in four or more degrees of freedom can still be achieved.

FIG. 5 is a schematic optical path diagram of a laser source module according to still another embodiment of the invention. Referring to FIG. 5, a laser source module 100c in the present embodiment is similar to the laser source module 100 in FIG. 1. Differences between the two are as follows. In a laser source module 100c and a laser stabilizing system 300c in the present embodiment, a beam steering device 200c further includes a diffusion sheet 240 disposed on the path of the laser beam 112, located on one side of the first prism 210 and the second prism 220, and configured to diffuse the laser beam 112. In addition, in the present embodiment, the first prism 210 and the second prism 220 are disposed in a motor 230c of the beam steering device 200c, so as to be controlled by the motor 230c in direction and position. In addition, the diffusion sheet 240 is connected to the motor 230c. The motor 230c drives the diffusion sheet 240 to rotate, for example, to rotate about a rotation axis 242 parallel to the third axial direction z. Vibration or rotation of the diffusion sheet 240 can effectively suppress a speckle phenomenon generated by the laser beam 112. In the present embodiment, the laser beam 112 emitted from the diffusion sheet 240 is transmitted to the first prism 210. However, in another embodiment, the diffusion sheet 240 may also be disposed on a path of the laser beam 112 emitted from the second prism 220.

Based on the above, in the laser stabilizing system and the laser source module in the embodiments of the invention, since the beam steering device that steers the direction and the position of the laser beam in four or more degrees of freedom is used, the laser stabilizing system and the laser source module can enable the laser beam to deflect and translate, are easily mounted in a narrow space, and may have a shorter optical path length, thereby effectively reducing the angle error of the laser beam.

What is claimed is:

1. A laser stabilizing system configured to stabilize a laser beam emitted from a laser source, the laser stabilizing system comprising:
a beam steering device disposed on a path of the laser beam and configured to steer a direction and a position of the laser beam in four or more degrees of freedom;
a first beam splitter disposed on a path of the laser beam from the beam steering device and configured to split the laser beam into a first partial beam and a second partial beam;
a first light detector disposed on a transmission path of the first partial beam;
a second beam splitter disposed on a transmission path of the second partial beam and configured to split the second partial beam into a third partial beam and a fourth partial beam; and
a second light detector disposed on a transmission path of the third partial beam.

2. The laser stabilizing system according to claim 1, wherein the beam steering device comprises:
a first prism having a first inclined reflecting surface; and
a second prism having a second inclined reflecting surface, wherein the laser beam is sequentially reflected by the first inclined reflecting surface and the second inclined reflecting surface, the first inclined reflecting surface is parallel to a first axial direction, the second inclined reflecting surface is parallel to a second axial direction, the first inclined reflecting surface is inclined with respect to a direction in which the laser beam is incident on the first inclined reflecting surface, and the second inclined reflecting surface is inclined with respect to a direction in which the laser beam is emitted from the second inclined reflecting surface.

3. The laser stabilizing system according to claim 2, wherein the first axial direction is perpendicular to the second axial direction.

4. The laser stabilizing system according to claim 2, wherein the beam steering device further comprises a motor, and the first prism and the second prism are disposed in the motor so as to be controlled by the motor in direction and position.

5. The laser stabilizing system according to claim 4, wherein the first prism and the second prism are disposed in a single motor, and the single motor is a motor capable of controlling in four or more degrees of freedom.

6. The laser stabilizing system according to claim 2, wherein the first prism further has a third inclined reflecting surface inclined with respect to the first inclined reflecting surface and parallel to the first axial direction, and the second prism further has a fourth inclined reflecting surface inclined with respect to the second inclined reflecting surface and parallel to the second axial direction, wherein the laser beam is sequentially reflected by the first inclined reflecting surface, the third inclined reflecting surface, the second inclined reflecting surface, and the fourth inclined reflecting surface, the third inclined reflecting surface is inclined with respect to a direction in which the laser beam is incident on the third inclined reflecting surface, and the fourth inclined reflecting surface is inclined with respect to a direction in which the laser beam is emitted from the fourth inclined reflecting surface.

7. The laser stabilizing system according to claim 2, wherein the beam steering device further comprises a diffusion sheet disposed on the path of the laser beam, located on one side of the first prism and the second prism, and configured to diffuse the laser beam.

8. The laser stabilizing system according to claim 7, wherein the beam steering device further comprises a motor, the first prism and the second prism are disposed in the motor so as to be controlled by the motor in direction and position, the diffusion sheet is connected to the motor, and the motor drives the diffusion sheet to rotate.

9. The laser stabilizing system according to claim 1, further comprising a controller electrically connected to the first light detector, the second light detector, and the beam steering device and configured to calculate, according to a position of a light spot formed by the first partial beam on the first light detector measured by the first light detector and a position of a light spot formed by the third partial beam on the second light detector measured by the second light detector, an angle and a position required to be compensated for the laser beam, and transmit a control signal to the beam steering device, so that the beam steering device compensates the angle and the position for the laser beam.

10. The laser stabilizing system according to claim 9, wherein the first light detector and the second light detector are both image sensors.

11. A laser source module comprising:
a laser source configured to emit a laser beam;
a beam steering device disposed on a path of the laser beam and configured to steer a direction and a position of the laser beam in four or more degrees of freedom;
a first beam splitter disposed on a path of the laser beam from the beam steering device and configured to split the laser beam into a first partial beam and a second partial beam;
a first light detector disposed on a transmission path of the first partial beam;
a second beam splitter disposed on a transmission path of the second partial beam and configured to split the second partial beam into a third partial beam and a fourth partial beam; and
a second light detector disposed on a transmission path of the third partial beam.

12. The laser source module according to claim 11, wherein the beam steering device comprises:
a first prism having a first inclined reflecting surface; and
a second prism having a second inclined reflecting surface, wherein the laser beam is sequentially reflected by the first inclined reflecting surface and the second inclined reflecting surface, the first inclined reflecting surface is parallel to a first axial direction, the second inclined reflecting surface is parallel to a second axial direction, the first inclined reflecting surface is inclined with respect to a direction in which the laser beam is incident on the first inclined reflecting surface, and the second inclined reflecting surface is inclined with respect to a direction in which the laser beam is emitted from the second inclined reflecting surface.

13. The laser source module according to claim 12, wherein the first axial direction is perpendicular to the second axial direction.

14. The laser source module according to claim 12, wherein the beam steering device further comprises a motor, and the first prism and the second prism are disposed in the motor so as to be controlled by the motor in direction and position.

15. The laser source module according to claim 14, wherein the first prism and the second prism are disposed in a single motor, and the single motor is a motor capable of controlling in four or more degrees of freedom.

16. The laser source module according to claim 12, wherein the first prism further has a third inclined reflecting surface inclined with respect to the first inclined reflecting surface and parallel to the first axial direction, and the second prism further has a fourth inclined reflecting surface inclined with respect to the second inclined reflecting surface and parallel to the second axial direction, wherein the laser beam is sequentially reflected by the first inclined reflecting surface, the third inclined reflecting surface, the second inclined reflecting surface, and the fourth inclined reflecting surface, the third inclined reflecting surface is inclined with respect to a direction in which the laser beam is incident on the third inclined reflecting surface, and the fourth inclined reflecting surface is inclined with respect to a direction in which the laser beam is emitted from the fourth inclined reflecting surface.

17. The laser source module according to claim 12, wherein the beam steering device further comprises a diffusion sheet disposed on the path of the laser beam, located on one side of the first prism and the second prism, and configured to diffuse the laser beam.

18. The laser source module according to claim 17, wherein the beam steering device further comprises a motor, the first prism and the second prism are disposed in the motor so as to be controlled by the motor in direction and position, the diffusion sheet is connected to the motor, and the motor drives the diffusion sheet to rotate.

19. The laser source module according to claim 11, further comprising a controller electrically connected to the first light detector, the second light detector, and the beam steering device and configured to calculate, according to a position of a light spot formed by the first partial beam on the first light detector measured by the first light detector and a position of a light spot formed by the third partial beam on the second light detector measured by the second light detector, an angle and a position required to be compensated for the laser beam, and transmit a control signal to the beam steering device, so that the beam steering device compensates the angle and the position for the laser beam.

20. The laser source module according to claim 19, wherein the first light detector and the second light detector are both image sensors.
